(19) United States
(12) Patent Application Publication
(10) Pub. No.: US 2012/0187302 A1
(43) Pub. Date: Jul. 26, 2012

(54) GAMMA-RAY SPECTROMETER

(76) Inventor: David Ramsden, Southampton (GB)

(21) Appl. No.: 13/388,961

(22) PCT Filed: Jul. 21, 2010
(86) PCT No.: PCT/GB2010/051194

§ 371 Date: Apr. 11, 2012

(30) Foreign Application Priority Data
Aug. 5, 2009 (GB) 0913670.6

(51) Int. Cl. G01T 1/36

(52) U.S. Cl. 250/362; 250/368

(57) ABSTRACT

A gamma-ray spectrometer comprising a scintillation body (34) for receiving gamma-rays and generating photons therefrom and a photodetector for detecting photons from the scintillation body and generating a corresponding output signal is described. The photodetector comprises a photocathode (26), an anode (28), and a reflecting surface (28A). The photocathode is arranged to receive photons from the source and generate photo-electrons therefrom. The anode is arranged to receive photoelectrons generated at the photocathode and is coupled to a detection circuit/amplifier configured to generate an output signal indicative of the photoelectrons received at the anode. The reflecting surface is arranged so as to reflect photons which have passed through the photocathode without interaction back towards the photocathode to provide the photons with another opportunity to interact with the photocathode, thus enhancing the overall effective quantum efficiency of the detector. The reflector may be specular or diffuse.

### BACKGROUND ART

The invention relates to gamma-ray spectrometers including photodetectors for detecting photons generated in gamma-ray scintillation events in the gamma-ray spectrometers. More specifically, the invention relates to gamma-ray spectrometers having photocathode-based photodetectors.

Photomultiplier tubes (PMTs) well-known photodetectors. PMTs are frequently used in gamma-ray spectrometers in a wide variety of applications, for example to identify and monitor gamma-ray sources in scientific, industrial, and environmental monitoring applications, e.g. for security screening of personnel and cargo at border crossings, or to search generally for orphaned radioactive sources. A common class of PMT-based gamma-ray spectrometer is based on organic (plastic) or inorganic (crystal) scintillator materials coupled to a PMT.

FIG. 1 schematically shows a conventional crystal scintillation spectrometer 2. The spectrometer is generally axially symmetric with a diameter of around 8 cm and a length of around 30 cm. The spectrometer 2 comprises a scintillation crystal 4 which scintillates when a gamma-ray is absorbed within it. A common scintillation crystal material is thallium-doped sodium iodide (NaI(Tl)). There are, however, various other scintillator crystals, and also scintillator plastics, that may be used.

The scintillation crystal 4 is in a hermetically sealed body 6 with Al₂O₃ powder packing arranged around the crystal 4 to act as a reflective material. A glass entrance window 8 is situated on the upper end-face of the package. Gamma-rays from a source enter the spectrometer through the entrance window 8, as schematically shown in FIG. 1 by incident gamma-ray γᵢ. Incident gamma-rays interact with the scintillation crystal 4 in scintillation events in which lower-energy photons are generated, e.g. optical photons, as schematically shown in FIG. 1 by scintillation photon γₛ. The scintillation crystal 4 is optically coupled to a PMT 10 for detecting photons γₛ generated in the scintillation crystal 4 in gamma-ray detection events.

The PMT 10 comprises a photocathode 12, a series of dynodes 14 (in this case five dynodes 14A-E), and an anode 16. The photocathode 12 is maintained at a reference potential, e.g. ground. A positive bias voltage +V_{bias} is applied to the anode 16. The respective dynodes 14A-E are maintained at voltages between ground and the bias voltage +V_{bias} so as to increase in voltage in steps between the photocathode 12 and the anode 16. E.g., in this example, the first dynode 14A may be held at one-sixth the bias voltage of the photocathode, the second dynode 14B at two-sixths, the third at three-sixths and so on.

The PMT 10 has an optical entrance window 11 at its interface with the scintillation crystal 4 such that scintillation photons γₛ can enter the PMT 10 and strike the photocathode 12. Scintillation photon interactions in the photocathode 12 generate photoelectrons. An example photoelectrons e⁻ generated by scintillation photon γₛ is schematically shown in FIG. 1. The photoelectron liberated from the photocathode 12 is accelerated towards the first dynode 14A by virtue of its positive potential relative to the photocathode. This increases the energy of the photoelectron such that when it strikes the first dynode 14A, further electrons are liberated. In this example, two electrons are schematically shown liberated from the first dynode 14A by the impact of the photoelectron from the photocathode. These two electrons are accelerated towards the second dynode 14B by virtue of its positive potential relative to the first dynode 14A. The two electrons strike the second dynode 14B such that each results in further electrons being liberated. This electron cascade process continues through the respective dynodes 14 towards the anode 16 such that a relatively high number of electrons are eventually liberated from the final dynode 14E and accelerated towards the anode 16, as schematically shown in FIG. 1.

The anode 16 is connected to a detection circuit 18. The electrons striking the anode disturb the potential of the anode resulting in a signal S that may be detected using conventional anode signal detection circuitry 18. The magnitude/amplitude of the signal S depends on the number of electrons in the cascade at the anode 16, which in turn depends on the number of scintillation photons generated in the gamma-ray interaction event. The detection circuitry 18 is thus configured to provide a corresponding output signal O indicative of the energy deposited in the scintillation crystal in the event. As is conventional for a gamma-ray spectrometer application, further circuitry my be provided to generate a spectrum of the amplitudes of the output signals O to provide an energy-loss spectrum for the gamma-ray interaction events.

Typically a PMT such as shown in FIG. 1 might include ten stages of electron multiplication (i.e. having ten dynodes instead of the five shown in FIG. 1). The PMT will typically require a power supply able to supply a bias voltage V_{bias} of around 1000 V, and also the appropriate DC voltages to the respective dynodes (e.g. around 100 V per stage).

PMTs have proven to be effective photodetectors, particularly for gamma-ray scintillation applications, but they have some drawbacks. For example, PMT detectors are relatively bulky because of the need for the multiple dynodes of the cascade stages, and PMTs also require relatively specialised power supplies. This need for a high voltage power supply and typically large size make PMTs particularly unsuitable for compact hand-held applications, for example. Also PMT detectors often require magnetic shielding to reduce changes in their effective gain as they are moved around.

There are alternative photodetection technologies available that have been used in place of PMT detectors. For example, while the use of a combination of a PMT and scintillation body is currently by far the most widely used technique in gamma-ray spectroscopy, alternative approaches have been followed for applications where only small-volume scintillation bodies are needed. For such applications, silicon PIN diodes and, more recently, silicon photomultipliers, have been used. Silicon-based diodes typically provide relatively high quantum-efficiency. However, the suitability of silicon-based photodetection diodes is often restricted by their relatively high detector capacitance and leakage current. These can be typically between 50 and 100 pF and 1 nA/cm² respectively for a good quality PIN diode, for example. These characteristics seriously constrain their use in gamma-ray spectroscopy because of the impact that they have on the noise generated in an associated charge-sensitive amplifier. Similarly the relatively high dark noise count-rates in silicon photomultipliers can limit their application to scintillation event counting applications.

Historically, vacuum diodes have also been used to detect scintillation light for some special applications. For example, vacuum diodes have been used with calorimeters designed to stop very high-energy particles/photons. In one specific example [1] a 50 mm diameter NaI(Tl) scintillation crystal has been viewed using a vacuum photodiode. However, this achieved a very poor spectral-resolution with a response to 662 keV mono-chromatic gamma-rays having of around full-width at half maximum (FWHM) of around 23%.

Vacuum photodiodes have also been used to measure the intensity of laser beams because of their relative linearity of response [2]. However, the relatively poor quantum efficiency of this kind of detectors makes is less suitable for more general applications, e.g., for gamma-ray spectrometry.

There is therefore a need for gamma-ray spectrometers having photodetectors which may be used more generally in place of conventional PMT detectors.

### SUMMARY OF THE INVENTION

According to a first aspect of the invention there is provided a gamma-ray spectrometer comprising a scintillation body for receiving gamma-rays and generating photons therefrom and a photodetector optically coupled to the scintillation body so as to detect photons generated by scintillation events in the scintillation body, wherein the photodetector comprises: a photocathode arranged to receive photons from the scintillation body and generate photoelectrons therefrom; an anode arranged to receive photoelectrons generated at the photocathode; and a reflecting surface arranged to reflect photons which have passed through the photocathode back towards the photocathode, and wherein a surface of the photocathode and a surface of the anode are in a substantially plane-parallel configuration, and wherein the separation between the anode and photocathode is less than a distance selected from the group comprising 1 mm, 2 mm, 3 mm, 4 mm and 5 mm.

The reflecting surface thus provides photons to be detected with an additional opportunity to interact with the photocathode and generate a photoelectron. This can help to increase the overall effective quantum efficiency of the photodetector. The quantum efficiency may be enhanced sufficiently in some examples to offset the impact of noise in the detection circuitry, for example. Thus a detector providing comparable performance to a PMT may be provided in a compact package and without requiring a complex power supply. For example, a photodetector for use in accordance with embodiments of the invention might require a voltage of only 60 V, or even less to operate, and furthermore may be provided in a package that is perhaps only a 1 cm or less deep. (The surface area of the detector may be matched to the application at hand).

The photodetector of the gamma-ray spectrometer may further comprise a sealed housing surrounding the photocathode and the anode, wherein the housing includes a transparent window arranged to allow photons from the scintillation body to enter the housing and be received at the photocathode. The reflecting surface may be inside or outside the sealed housing.

For example, the reflecting surface may be outside the sealed housing and the sealed housing may thus include a transparent window arranged to allow photons which have passed through the photocathode to reach the reflecting surface and be reflected back into the sealed housing towards the photocathode. The reflecting surface may, for example, comprise a coating deposited directly on such an exit window.

The anode may be configured to allow photons to pass through it. A configuration in which photons can pass through the anode can help in providing photons with multiple opportunities to interact with the photocathode material. For example, the anode may comprise a transparent conductor, or may include openings, e.g. in a mesh/grid pattern.

Various configurations may be employed. For example, the reflecting surface and the anode may be on opposing sides of the photocathode. In some examples, the detector may further comprise a second photocathode arranged such that the first-mentioned photocathode and the second photocathode are located on opposing sides of the anode. The reflecting surface and the anode may be on opposing sides of the second photocathode.

In one example the reflecting surface may be a surface of the anode itself.

According to a second aspect of the invention there is provided a method of gamma-ray spectrometry comprising providing a gamma-ray spectrometer comprising a scintillation body for receiving gamma-rays and generating photons therefrom and a photodetector optically coupled to the scintillation body so as to detect photons generated by scintillation events in the scintillation body by receiving photons at a photocathode of the photodetector and generating photo-electrons therefrom, receiving photoelectrons generated at the photocathode at an anode of the photodetector, and reflecting photons which have passed through the photocathode back towards the photocathode, and wherein a surface of the photocathode and a surface of the anode are in a substantially plane-parallel configuration, and wherein the separation between the anode and photocathode is less than a distance selected from the group comprising 1 mm, 2 mm, 3 mm, 4 mm and 5 mm.

### BRIEF DESCRIPTION OF THE DRAWINGS

For a better understanding of the invention and to show how the same may be carried into effect reference is now made by way of example to the accompanying drawings (not to scale) in which:

FIG. 1 schematically shows a scintillator-based gamma-ray spectrometer employing a conventional photomultiplier tube photodetector;

FIG. 2 schematically shows a scintillator-based gamma-ray spectrometer employing a photodetector according to an embodiment of the invention;

FIG. 3 schematically shows a photodetector for use in a gamma-ray spectrometer according to another embodiment of the invention; and

FIG. 4 schematically shows a photodetector for use in a gamma-ray spectrometer according to still another embodiment of the invention.

### DETAILED DESCRIPTION

Spectral resolution is often the primary parameter of interest for scintillator-based gamma-ray spectrometers. Accordingly, for these applications at least, any new design of photodetector should preferably provide a spectral resolution that is broadly comparable to, or better than, that provided by conventional PMT detectors.

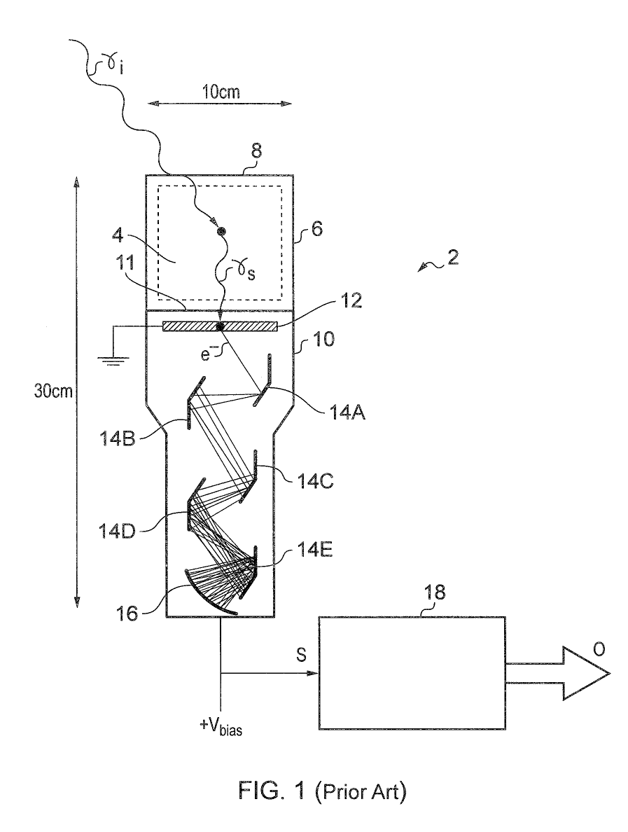

For a scintillator-based gamma-ray spectrometer, e.g. one using a PMT photodetector such as shown in FIG. 1, the achievable spectral resolution depends on a number of factors These include:

(a) The light-yield of scintillation events. This is the typical number of optical scintillation photons γₛ generated in a gamma-ray interaction event per MeV of energy deposited in the scintillation crystal. Typical values are on the order of several tens of thousands of photons per MeV. For example, a conventional LaBr scintillator crystal might have a light yield of around 66000 γₛ/MeV, and a NaI(TI) scintillator crystal might have a light yield of around 45000 γₛ/MeV.

(b) The light collection efficiency (LCE). This is a measure of the fraction of optical scintillation photons generated in the scintillation crystal that can be expected to reach the photodetector. The LCE is primarily determined by the optical qualities of the scintillation crystal packaging (typically a diffuse reflector) and the coupling between the crystal and the PMT. The structural properties of the scintillation crystal itself (e.g. its shape) can also affect the LCE. A typical LCE might be around 80%.

(c) The quantum efficiency (QE) of the photocathode. This depends on the material of the photocathode and the wavelength of the optical scintillation photons. Values typically range from 0.25 to 0.4, for example,

These three terms (a), (b) and (c) together combine to affect the variance in observed signals due to counting statistics (σ-statistics).

Other relevant factors include:

(d) The linearity of the response of the scintillator material determines what may be referred to as the ‘intrinsic resolution’ of the scintillation crystal. For a given energy deposit, the light yield can vary significantly from event to event in a non-statistical way. A further contribution to the intrinsic resolution of the scintillation crystal results from differences in LCE for gamma-ray events occurring at different locations in the crystal. These two effects together combine to affect the variance in the observed signals due to intrinsic properties of the scintillator (σ-intrinsic). In some materials, the scintillator's intrinsic resolution contribution (σ-intrinsic) may have a similar magnitude to the statistical variance (σ-statistics).

(e) Finally, noise may be added either from thermally excited electrons from the photocathode, or from the read-out electronics. This contribution to the variance in observed signals may be thought of as primarily resulting from amplifier noise (σ-amplifier). The contribution σ-amplifier is often negligible for PMT detectors because of their high internal gain resulting from the electron cascade process. However, σ-amplifier can be more significant for other types of photodetector.

Table 1 shows typical performance data for different scintillator-based gamma-ray spectrometers employing conventional PMT photodetectors. Data are shown for two commonly used scintillation crystals (LaBr and NaI(Tl)) in conjunction with two example PMT photocathode types, namely a bi-alkali photocathode and a higher performance SBA (“Super Bi-Alkali) photocathode.

There are thus four combinations of scintillation crystal and photocathode shown in the table.

TABLE 1

| 1 | 2 | 3 | 4 | | | | | 9 | 10 | | 12 |
|---|---|---|---|---|---|---|---|---|---|---|---|
| Photo- | Scint. | Light | λₘₐₓ | 5 | 6 | 7 | 8 | σ- | σ- | 11 | FWHM |
| cathode | Crystal | Yield | (nm) | LCE | QE | q/Mev | q/662 | stat. | intrin. | σ-tot | 662 |
| SBA | LaBr | 66000 | 390 | 0.8 | 0.38 | 20064 | 13242 | 115 | 85 | 143 | 2.5% |
| Bialkali | LaBr | 66000 | 390 | 0.8 | 0.25 | 13200 | 8712 | 93 | 85 | 126 | 3.3% |
| SBA | NaI(Tl) | 45000 | 415 | 0.8 | 0.34 | 12240 | 8078 | 90 | 150 | 175 | 5.0% |
| Bialkali | NaI(Tl) | 45000 | 415 | 0.8 | 0.25 | 9000 | 5940 | 77 | 150 | 169 | 6.5% |

The first column lists the photocathode type and the second column lists the scintillation crystal type. The third column lists the light yield in photons/MeV for the scintillation crystal type. The fourth column (“λₘₐₓ”) lists the wavelength of maximum scintillation emission in nm for the scintillation crystal type. The fifth column lists the assumed LCE for the scintillation crystal, i.e. 80% for both types. The sixth column (“QE”) lists the typical quantum efficiency for the photocathode type and peak emission wavelength associated with the scintillation crystal.

The seventh column (“q/MeV”) lists the number of photoelectrons generated at the photocathode per MeV energy deposit (i.e. Light yield*LCE*QE). The eighth column (“q/662”) lists the approximate number of photoelectrons generated at the photocathode per energy deposit associated with a 662 keV gamma-ray (i.e. Light yield*LCE*QE*0.66).

The ninth column lists the statistical variances “σ-statistics” associated with a 662 keV energy deposit. This is the square root of the value for “q/662” in the preceding column.

The tenth column lists the typical intrinsic variances “σ-intrinsic” associated with the respective scintillation crystal types.

The eleventh column lists the total signal variances “σ-total” associated with a 662 keV energy deposit. This is obtained by adding the respective statistical variances “σ-statistics” and intrinsic variances “σ-intrinsic” in quadrature. Because the photodetector is a PMT, it is assumed there is no amplifier noise contribution to the total signal variance “σ-total”.

The final (twelfth) column shows for the different combinations of scintillation crystal and photocathode types the expected FWHM that would be seen in an observed spectrum associated with mono-energetic energy deposits at 662 keV (i.e. 2.35*σ-total/(q/662)). Experimental measures of FWHM for spectral features at 662 keV using a conventional PMT with a bi-alkali photocathode agree well with the predictions of Table 1.

It can be seen from the predicted spectral resolutions of Table 1 (parameterised by the FWHM at 662 keV), that the best results can be expected for a LaBr scintillation crystal used in conjunction with a PMT having a SBA photocathode. This combination provides a spectral resolution corresponding to a FWHM at 662 keV of 2.5%. Other combinations are associated with spectral resolutions corresponding to a FWHM at 662 keV of between 3.3% and 6.5%.

As a practical matter for gamma-ray spectroscopy application (though not necessarily for all applications), it may be seen as important that any new photo-detector concept should not perform significantly worse so far as spectral resolution is concerned than can be achieved using a standard bi-alkali photocathode PMT.

As noted above, some of the drawbacks of conventional PMT photodetectors primarily stem from the multi-stage dynode arrangement which adds complexity to the required power supply and physical bulk to the overall design, and can require magnetic shielding to reduce changes in gain as the PMT is moved about.

A conventional vacuum photodiode is in effect a PMT without the dynodes, and so does not suffer from these drawbacks. However, a vacuum photodiode cannot provide the same detection performance as PMT. This is because without the internal dynode cascade amplification, it is generally necessary to provide an external charge/current amplifier for vacuum photodiode detectors. The amplifier adds noise, which increases the overall variance of observed signals. As noted above, the variance contribution associated with an external amplifier (σ-amplifier) is zero for a PMT since no external amplifier is required to detect the signals. However, for a vacuum photodiode, a contribution to the overall variance in count rates associated with a 662 keV energy deposit might be expected to be around σ-amplifier=200 counts, for example.

Table 2 is similar to, and will be understood, from Table 1, but shows corresponding modelled performance data for a vacuum photodiode photodetector (as opposed to a PMT detector). Data are shown for the same scintillation crystals and photocathode material, but include the effects of a charge amplifier contributing a component σ-amplifier=200 counts to the total variance σ-total.

TABLE 2

| 1 | 2 | 3 | 4 | | | | | 9 | 10 | 11 | | 13 |
|---|---|---|---|---|---|---|---|---|---|---|---|---|
| Photo- | Scint. | Light | λₘₐₓ | 5 | 6 | 7 | 8 | σ- | σ- | σ- | 12 | FWHM |
| cathode | Crystal | Yield | (nm) | LCE | QE | q/Mev | q/662 | stat. | intrin. | amp | σ-tot | 662 |
| SBA | LaBr | 66000 | 390 | 0.8 | 0.38 | 20064 | 13242 | 115 | 85 | 200 | 246 | 4.3% |
| Bialkali | LaBr | 66000 | 390 | 0.8 | 0.25 | 13200 | 8712 | 93 | 85 | 200 | 236 | 6.3% |
| SBA | NaI(Tl) | 45000 | 415 | 0.8 | 0.34 | 12240 | 8078 | 90 | 150 | 200 | 266 | 7.6% |
| Bialkali | NaI(Tl) | 45000 | 415 | 0.8 | 0.25 | 9000 | 5940 | 77 | 150 | 200 | 262 | 10.2% |

Thus columns 1 to 10 of Table 2 are the same as columns 1 to 10 of Table 1. However, Table 2 includes a new column 11 listing the amplifier noise contribution (σ-amplifier) to the overall variance. This is associated with the need for an external charge/current amplifier in a vacuum photodiode implementation as compared to a PMT implementation. This is assumed here to be 200 counts (i.e. corresponding to 200 photoelectrons).

The twelfth column of Table 2 lists the total signal variances “σ-total” associated with a 662 keV energy deposit. This is obtained by adding the respective variances “σ-statistics”, “σ-intrinsic” and “σ-amplifier” in quadrature. This column thus corresponds with the eleventh column of Table 1, but includes the additional effects of the amplifier noise.

The final (thirteenth) column of Table 2 corresponds with the twelfth column of Table 1 and shows the expected FWHM for a vacuum photodiode detector at 662 keV for the performance characteristics listed elsewhere in the table. It can be seen from this that the predicted spectral resolution for a vacuum photodiode is significantly worse (e.g. almost a factor of two worse) than the corresponding performance of a PMT detector.

Embodiments of the present invention are based on a realisation that the spectral resolution of a gamma-ray spectrometer using a vacuum photodiode type photodetector can be improved by providing the scintillation photons with more than one opportunity to interact with the photocathode and release photoelectrons. This in effect enhances the effective quantum efficiency of the detector, which reduces the magnitude of the contribution σ-statistics. Calculations show that enhancing a photocathode's effective quantum efficiency by a factor on the order of two or so will typically balance the additional noise contribution from an external amplifier.

FIG. 2 schematically shows features of a scintillator-based gamma-ray spectrometer employing a photodetector 20 according to an embodiment of the invention. The spectrometer comprises a scintillator component 32 and the photodetector 20. The scintillator component 32 comprises a scintillation crystal 34 in a housing 36. The scintillator component 32 may be completely conventional. The photodetector 20 comprises an entrance window 24, e.g. of quartz-glass, optically coupled to the scintillator component 32. The photodetector 20 may be optically coupled to the scintillation crystal 34 via its entrance window in the same way as the entrance window of a conventional PMT might be optically coupled to a scintillation crystal. The scintillator component 32 and photodetector 20 are shown separated by a gap 38 in FIG. 2, but this is only for ease of representation. In practice the photodetector 20 will generally be close-coupled to the scintillator component 32, either directly, or via a light-guiding spacer.

The photodetector 20 comprises a housing 22 in which the entrance window 24 is mounted. Within the housing the photodetector 20 further comprises a photocathode 26 electrically coupled to a system reference potential (ground) and an anode 28 electrically coupled to a positive bias potential (+V_{bias}) relative to the photocathode 26. A typical anode bias voltage might be around 60 to 100 V, for example. The anode 28 is further electrically coupled to a charge amplifier 30 operable to detect and amplify a signal corresponding to an electrical disturbance on the anode caused by the impact of electrons. The charge amplifier 30 may be conventional and is arranged to provide an output signal O representing a magnitude of electrical disturbance at the anode caused by impacting electrons.

The photocathode 26 may comprise any conventional photocathode material, for example as might be used in a conventional PMT or vacuum photodiode. In this example, the photocathode 26 is a bi-alkali photocathode (e.g. KCsSb and RbCsSb). The photocathode is sufficiently thin as to operate in transmission mode whereby it is partially transparent to incident photons. FIG. 2 is not drawn to scale in that in practice the photocathode 26 will typically be relatively closer to the entrance window 24 than is shown in the figure. Indeed, in some embodiments the photocathode may be deposited directly on the entrance window surface itself.

The anode 28 and photocathode 26 are arranged in a generally plane-parallel configuration. Furthermore, the surface 28A of the anode 28 facing the photocathode 26 is polished and/or coated so as to provide a surface that is specularly reflective to photons at wavelengths to which the photocathode 26 is sensitive. The areal extents of the entrance window 24 and photocathode 26 are chosen to broadly match the end face of the scintillation crystal 34 (or associated light guide), and also one another, in accordance with the same general principles as would apply for the entrance window and photocathode of a conventional PMT coupled to a scintillator. The areal extent of the anode 28 is chosen to broadly match that of the photocathode 26.

In use an incident gamma-ray γᵢ interacts with the scintillation crystal at an interaction site 40 to generate scintillation photons γₛ. The number of scintillation photons γₛ generated in an event depends on the energy deposited in the crystal and the material of the crystal (e.g. see columns 7 and 8 of Tables 1 and 2 above). Only one scintillation photon γₛ is shown in FIG. 2 for simplicity. Scintillation photons γₛ are coupled from the scintillation body 34 to the entrance window 24 of the photodetector 20 in the usual way, e.g., directly or through reflection(s) at the surface(s) of the scintillation body. As noted above, one might typically expect around 80% or so of the scintillation photons to reach the photodetector (e.g. see column 5 of Tables 1 and 2 above).

As schematically indicated in FIG. 2, the scintillation photon γₛ enters the photodetector 20 through the transparent entrance window 24 and goes on to enter the semi-transparent photocathode 26. The scintillation photon γₛ may thus interact with the photocathode 26 to generate a photoelectron, schematically indicated as e₁ in FIG. 2. This is in accordance with the well understood principles of the photoelectric effect. The likelihood of generating a photoelectron in such an interaction relates to the quantum efficiency of the photocathode (e.g. see column 6 of Tables 1 and 2 above). If the scintillation photon γₛ fails to generate a photoelectron, it may pass through the semi-transparent photocathode 26 and out the other side. Thus the likelihood of a photoelectron being generated in this first pass is QE, and the likelihood of the photon passing through is 1-QE (ignoring other photon absorption mechanisms). Both of these alternatives are represented in FIG. 2 to represent the possibility of either occurring.

It may be noted the quantum efficiency QE will depend slightly on the angle of incidence. This is because different angles are associated with different photon path lengths through the photocathode 26, and longer path lengths are associated with a greater likelihood of photoelectron generation. However, one cannot simply continue to increase the photocathode thickness to increase quantum efficiency. This is because as the photocathode becomes thicker, there is a corresponding reduction in the likelihood of photoelectrons escaping the photocathode.

If a photoelectron e₁ is generated in this first pass it will be accelerated towards the anode 28 by virtue of the anode's positive potential relative to the photocathode 26.

However, if the scintillation photon γₛ does not interact in the photocathode 26 on its first pass (i.e. the photoelectron e₁ in FIG. 2 is not created), the scintillation photon γₛ passes through the semi-transparent photocathode 26 and strikes the reflecting surface 28A of the anode 28. The scintillation photon γₛ is thus reflected back towards the photocathode 26. This gives the scintillation photon γₛ a second chance to interact with the photocathode 26 to generate a photoelectron, schematically indicated as e₂ in FIG. 2. The likelihood of generating a photoelectron in this second pass through the photocathode 26 again relates to the quantum efficiency of the photocathode (column 6 of Tables 1 and 2 above). If the scintillation photon γₛ fails to generate a photoelectron in this second pass, it again continues through the semi-transparent photocathode 26 and out the other side back towards the entrance window 24. The likelihood of a photoelectron being generated by a photon making a second pass is again QE, and the likelihood of the photon passing through is 1-QE (ignoring other photon absorption mechanisms). Both of these alternatives are again represented in FIG. 2 to represent the possibility of either occurring.

A photoelectron e₂ generated in a second pass will similarly be accelerated towards the anode 28 by virtue of the anode's positive potential relative to the photocathode 26.

Thus the reflective surface 28A of the anode 28 provides photons to be detected with multiple opportunities to interact with the photocathode and generate photoelectrons, thus increasing the effective quantum efficiency of the photodetector. For example, if the bi-alkali photocathode 26 is assumed to have an inherent quantum efficiency of around 0.25, and the reflecting surface 28A of the anode 28 is assumed to have a reflection coefficient (at the wavelength of interest) of around 0.8, the effective quantum efficiency becomes approximately [0.25+(0.75*0.8*0.25)]=0.40. Thus the reflecting surface improves the effective quantum efficiency of the photodetector by around 60%.

The effective quantum efficiency may be increased further as a result of photons leaving the photodetector 20 to re-enter the scintillation body 34, and then bouncing around that until they re-enter the photodetector 20 for a second time and corresponding further opportunities to interact with the photocathode.

Thus to summarize some embodiments of the invention, a gamma-ray spectrometer comprises a photodetector configured in such a way that scintillation light is provided with multiple opportunities to interact with a semi-transparent photocathode material. That is to say, photons that pass through and exit the photocathode are guided through reflection to re-enter the photocathode a second, and possibly more, times.

In the specific example of FIG. 2, the anode 28 is specularly reflecting so as to reflect back light which passes through the photocathode on its first pass, whilst also collecting any photoelectrons that have been generated. In this configuration, the separation between the anode 28 and the photocathode 26 may, for example, be on the order of a few mm, e.g. 1, 2, 3, 4 or 5 mm or so. This can help reduce the overall capacitance of the photodetector. This can be an important consideration for some implementations since low detector capacitance can help reduce noise in the amplifier used to convert the small signal charge into a more readily useable output voltage.

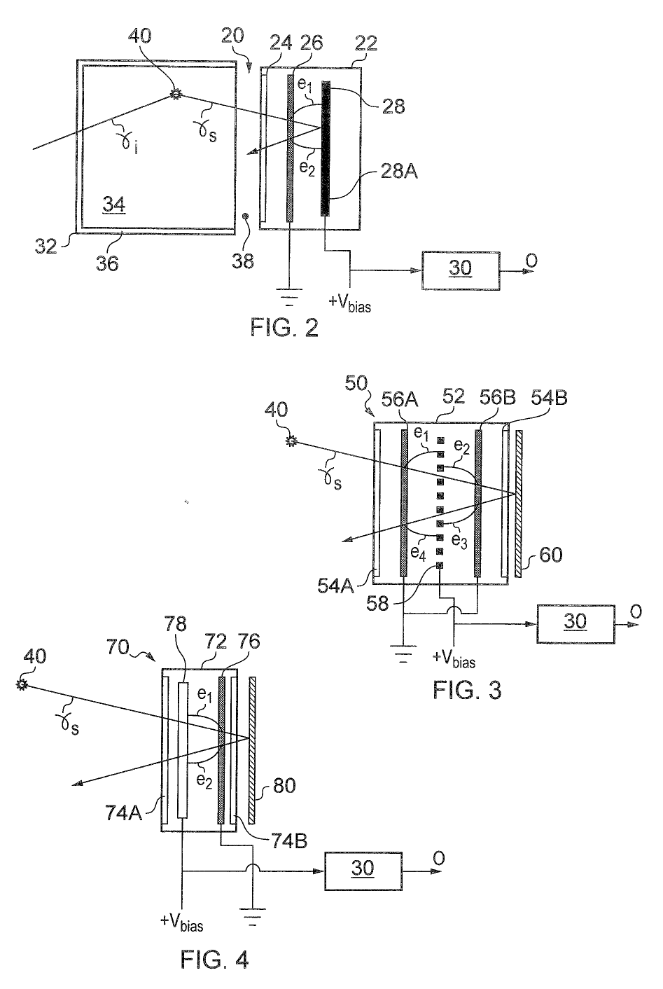

FIG. 3 schematically shows features of a scintillator-based gamma-ray spectrometer employing a photodetector 50 according to another embodiment of the invention. Many aspects of the embodiment of FIG. 3 are similar to, and will be understood, from corresponding features of the embodiment of FIG. 2, and are not described in detail again in the interest of brevity.

The spectrometer again comprises a scintillator component coupled to the photodetector 50. The scintillator component is not shown in FIG. 3, but may be the same as that shown in FIG. 2. The photodetector 50 comprises an entrance window 54A, e.g. of quartz-glass, optically coupled to the scintillator component. The photodetector 50 further comprises a housing 52 in which the entrance window 54A is mounted. An exit window 54B is also provided on an opposing side of the housing 52.

Within the housing the photodetector 50 further comprises first and second photocathodes 56A, 56B electrically coupled to a system reference potential (ground). Although schematically shown as discrete structures in FIG. 3 for ease of representation, the photocathodes 56A, 56B will typically comprise a layer of photocathode material deposited on the respective inner faces of the windows 54A, 54B.

The first and second photocathodes 56A, 56B are disposed on either side of an anode 58 which is electrically coupled to a positive bias potential (+V_{bias}) relative to the photocathodes 56A, 56B. Again a typical anode bias voltage might be around 60 to 100 V, for example. The anode 58 is electrically coupled to a charge amplifier 30 as in FIG. 2. The anode 58 in this example in the form of a relatively open mesh/grid so that photons can readily pass through.

The photodetector 50 of FIG. 3 further comprises a reflector 60 that is external to the housing 52 and adjacent the exit window 54B. The reflector 60 in this example comprises a diffusive reflecting surface (in another example the reflector 60 may comprise a specular reflecting surface). The reflector 60 and the exit window 54B are shown in FIG. 3 as separate structures for ease of representation, but in practice the reflector 60 may be provided by a suitable coating applied directly to the exit window 54B.

In use a scintillation photon γₛ enters the photodetector 50 through the transparent entrance window 54A and goes on to enter the first semi-transparent photocathode 56A. The scintillation photon γₛ may interact with the first photocathode 56A to generate a photoelectron e₁ (with a probability related to the inherent quantum efficiency of the photocathode). Alternatively, the photon may pass through the first photocathode 56A, through a gap in the anode 58, and on into the second semi-transparent photocathode 56B. The scintillation photon γₛ may then interact with the second photocathode 56B to generate a photoelectron e₂ (again with a probability related to the quantum efficiency of the photocathode). Alternatively, the photon may continue on to pass through the second photocathode 56B.

If the photon passes through the second photocathode, it continues on to the diffusive reflector 60 where it is reflected back towards and enters the second photocathode 56B. The scintillation photon γₛ thus has a second opportunity to interact with the second photocathode 56A to generate a photoelectron, as schematically indicated as e₃ in the figure.

If the scintillation photon γₛ still fails to generate a photoelectron in the second photocathode, the photon may continue on through the photocathode, through another gap in the anode 58, and back into the first photocathode 56A for a second time. Here the scintillation photon γₛ has a fourth opportunity to interact with one of the photocathodes 56A, 56B to generate a photoelectron such as schematically indicated as e₄ in the figure.

As for the example shown in FIG. 1, a photon that does not interact with either photocathode in any of the passes (and which makes it though the gaps in the anode) may be redirected back to the photocathodes again. E.g. by back-reflection from within the scintillation crystal.

Thus the reflective surface 60 of FIG. 3 again provides photons to be detected with multiple opportunities to interact with the photocathodes of the detector and generate photoelectrons, thus increasing the effective quantum efficiency of the photodetector. For example, if the bi-alkali photocathodes 56A, 56B are assumed to have inherent quantum efficiencies of around 0.25 for photons at an average angle of incidence and 0.26 for photons at an average angle of reflectance, and the mesh/gridded anode is assumed to have a “fill factor” of 0.3, and the diffuse reflecting surface 60 is assumed to have a reflection coefficient of around 0.6, the effective quantum efficiency becomes approximately [0.25+(0.75*0.7*0.25)+(0.75*0.7*0.6*0.26)+(0.75*0.7*0.6*0.74*0.7*0.26)]=0.5. This represents a 100% improvement in the effective quantum efficiency of the photodetector.

Thus to summarize the example of FIG. 3, a vacuum enclosure has two quartz-glass windows on which photocathode material has been deposited. The entrance window which is optically coupled to the scintillation crystal, supports the first photocathode. In this case, the anode consists of a ‘transparent’ grid which collects the photoelectrons from both the first photocathode and the photocathode that has been deposited on a second (“exit”) quartz-glass window. This window is also coated with a highly reflective surface. This reflector in this case is diffuse, but in other examples it may be a specular reflector.

The arrangement of FIG. 3 thus provides a photon passing through the detector with four chances to interact with the photocathode material to generate a photoelectron. Any photoelectrons that are generated are again accelerated towards the anode and detected by the charge/current amplifier 30 for detection in the usual way.

FIG. 4 schematically shows features of a scintillator-based gamma-ray spectrometer employing a photodetector 70 according to another embodiment of the invention. Many aspects of the embodiment of FIG. 4 are similar to and will be understood from corresponding features of the embodiments of FIGS. 2 and 3, and are not described in detail again in the interest of brevity.

The spectrometer again comprises the photodetector 70 coupled to a scintillator component (not shown in FIG. 4). The photodetector 70 comprises an entrance window 74A optically coupled to the scintillator component and a housing 72 in which the entrance window 74A is mounted. An exit window 74B is also provided on an opposing side of the housing 72.

Within the housing the photodetector 70 further comprises a photocathode 76 electrically coupled to ground and a transparent anode 78. The anode comprises a transparent conductor (e.g. Indium Tin Oxide—ITO), and the photocathode material may again be conventional. The anode 78 and photocathode 76 are schematically shown as distinct structures in FIG. 4 for ease of representation. In practice, however, the anode 78 will typically be deposited directly on the inner faces of the entrance window 74A and the photocathode 76 will typically be deposited directly on the inner faces of the exit window 74A. As before, a typical anode bias voltage might be around 60 to 100 V relative to the photocathode. The anode 78 is again electrically coupled to a conventional charge amplifier 30 for detecting electrons received at the anode in the usual way.

The photodetector 70 further comprises a specular reflector 80 external to the housing 72. The reflector 80 and the exit window 74B are shown separately, but in practice the reflector 80 may be provided by a coating applied directly to the exit window 74B.

In use a scintillation photon γₛ enters the photodetector 70 through the transparent entrance window 74A. The photon passes through the transparent anode 78 and goes on to enter the semi-transparent photocathode 76. The scintillation photon γₛ may thus interact with the photocathode 76 to generate a photoelectron, schematically indicated as e₁ in FIG. 4. If the photon passes through the photocathode 76, it continues on to the reflector 80 where it is reflected back towards and re-enters the photocathode 76. The scintillation photon γₛ thus has a second opportunity to interact with the photocathode 76 to generate a photoelectron, as schematically indicated as e₂ in the figure. If the scintillation photon γₛ fails to generate a photoelectron in this second pass, it again continues through the semi-transparent photocathode 26 and out the other side back towards the entrance window 24.

The arrangement of FIG. 4 thus provides a photon passing through the detector with two chances to interact with the photocathode to generate a photoelectron. Any photoelectrons that are generated are accelerated towards the anode and detected by the charge/current amplifier 30 to provide a corresponding output signal O in the usual way.

Thus to summarize the example of FIG. 4, a transparent, conductive layer of ITO provides the anode which collects the photo-electrons from the semi-transparent photocathode which is deposited on the rear quartz-glass window. This window is provided with a highly reflective surface (specular in this case, but may be diffuse) which can help in efficiently returning any light that has passed through the photocathode. The reflecting surface could equally be provided inside the housing, e.g. as a discrete structure or a coating on an inner wall of the housing, in an embodiment without an exit window.

Thus the example embodiments of the invention shown in FIGS. 2 to 4 demonstrate how the provision of a reflecting surface in a photocathode/anode photodetector can lead to an increase in the effective quantum efficiency of the device.

Calculations suggest that that the effective quantum-efficiency of detector configurations similar to those described above could reach 75%. To demonstrate the potential impact of this increase in effective quantum efficacy on performance in a gamma-ray spectrometer application, Table 3 shows performance data similar to that shown in Table 2. However, whereas Table 2 is based on the inherent quantum efficiency of a conventional vacuum photodiode, Table 3 shows corresponding data for a range of different effective quantum efficiencies (as listed in column 6) for the two types of scintillation crystal (although only for the bi-alkali photocathode). As with Table 2, it is assumed that a relatively inexpensive charge-sensitive amplifier having an rms noise equivalent to 200 electrons is used.

TABLE 3

| 1 | 2 | 3 | 4 | | | | | 9 | 10 | 11 | | 13 |
|---|---|---|---|---|---|---|---|---|---|---|---|---|
| Photo- | Scint. | Light | λₘₐₓ | 5 | 6 | 7 | 8 | σ- | σ- | σ- | 12 | FWHM |
| cathode | Crystal | Yield | (nm) | LCE | QE | q/Mev | q/662 | stat. | intrin. | amp | σ-tot | 662 |
| Bi-alkali | LaBr | 66000 | 390 | 0.8 | 0.75 | 39600 | 26136 | 162 | 85 | 200 | 271 | 2.4% |
| Bi-alkali | LaBr | 66000 | 390 | 0.8 | 0.70 | 36960 | 24394 | 156 | 85 | 200 | 268 | 2.5% |
| Bi-alkali | LaBr | 66000 | 390 | 0.8 | 0.65 | 34320 | 22651 | 151 | 85 | 200 | 265 | 2.7% |
| Bi-alkali | LaBr | 66000 | 390 | 0.8 | 0.60 | 31680 | 20909 | 145 | 85 | 200 | 261 | 2.9% |
| Bi-alkali | LaBr | 66000 | 390 | 0.8 | 0.55 | 29040 | 19166 | 138 | 85 | 200 | 257 | 3.1% |
| Bi-alkali | LaBr | 66000 | 390 | 0.8 | 0.50 | 26400 | 17424 | 132 | 85 | 200 | 254 | 3.4% |
| Bi-alkali | LaBr | 66000 | 390 | 0.8 | 0.45 | 23760 | 15682 | 125 | 85 | 200 | 251 | 3.7% |
| Bi-alkali | NaI(Tl) | 45000 | 415 | 0.8 | 0.75 | 27000 | 17820 | 133 | 150 | 200 | 283 | 3.7% |
| Bi-alkali | NaI(Tl) | 45000 | 415 | 0.8 | 0.70 | 25200 | 16632 | 129 | 150 | 200 | 281 | 3.9% |
| Bi-alkali | NaI(Tl) | 45000 | 415 | 0.8 | 0.65 | 23400 | 15444 | 124 | 150 | 200 | 279 | 4.2% |
| Bi-alkali | NaI(Tl) | 45000 | 415 | 0.8 | 0.60 | 21600 | 14256 | 119 | 150 | 200 | 277 | 4.5% |
| Bi-alkali | NaI(Tl) | 45000 | 415 | 0.8 | 0.55 | 19800 | 13068 | 114 | 150 | 200 | 275 | 4.9% |
| Bi-alkali | NaI(Tl) | 45000 | 415 | 0.8 | 0.50 | 18000 | 11880 | 109 | 150 | 200 | 273 | 5.3% |
| Bi-alkali | NaI(Tl) | 45000 | 415 | 0.8 | 0.45 | 16200 | 10692 | 103 | 150 | 200 | 270 | 5.8% |

Thus it can be seen the predicted spectral-resolution with a LaBr crystal scintillator in conjunction with a non-PMT bi-alkali photodetector employing a charge amplifier with an rms noise of 200 electrons would match that achievable with a PMT detector (3.3%—see Table 1) if the effective QE of the photocathode could be increased to around 50%. This is broadly in line with the simple prediction set out above for the increase in effective QE provided by the design of FIG. 3, for example.

Thus the impact of amplifier noise on the overall performance characteristics for non-PMT detectors can, at least to some extent, be traded-off against increasing effective quantum-efficiency. Higher quality charge amplifiers (e.g. with an rms noise of perhaps 100 electrons) could be used such that the overall system performance using a photodiode detector with enhanced quantum efficiency in accordance with embodiments of the invention could exceed the performance of the more cumbersome PMT-based schemes.

Thus by enhancing the effective quantum efficiency of a vacuum photodiode by providing for reflection of photons in accordance with embodiments of the invention, a photodetector with performance characteristics which may be comparable to, or exceed, a conventional PMT detector may be provided, and which does not suffer from the above-identified drawbacks associated with PMT detectors.

It will be appreciated that while the reflecting surfaces of the various examples described above are shown flat, in other examples the reflecting surfaces may be curved (e.g. concave as viewed from the photocathode). This can help provide photons reflected from near the periphery of the reflecting surface with an increased likelihood of being directed back towards the photocathode (as opposed to past it). It will thus be appreciated that references to a plane parallel configuration should be interpreted accordingly to incorporate configurations such as this. That is to say “plane parallel” should not be interpreted strictly as necessitating flat surfaces which are exactly parallel, but should be interpreted to include surfaces which are generally planar and parallel, but which may have some curvature, e.g. to allow for photon “focusing”.

It will also be appreciated that while the above description has primarily described photodetectors in the context of gamma-ray scintillator applications in accordance with embodiments of the invention, such photodetectors may also be used in applications which are not in accordance with embodiments of the invention. For example, such photodetectors might be used in any situations where PMT detectors might normally otherwise be used, or for general photodetection.

Thus there has been described a gamma-ray spectrometer comprising a scintillation body for receiving gamma-rays and generating photons therefrom and a photodetector for detecting photons from the scintillation body and generating a corresponding output signal. The photodetector comprises a photocathode, an anode, and a reflecting surface. The photocathode is arranged to receive photons from the scintillation body and generate photo-electrons therefrom. The anode is arranged to receive photoelectrons generated at the photocathode and is coupled to a detection circuit/amplifier configured to generate an output signal indicative of the photoelectrons received at the anode. The reflecting surface is arranged so as to reflect photons which have passed through the photocathode without interaction back towards the photocathode to provide the photons with another opportunity to interact with the photocathode, thus enhancing the overall effective quantum efficiency of the detector. The reflector may be specular or diffuse.

### REFERENCES

[1] I Yu Redko et al Instrument Technology 29 (1986), pp. 346-349
[2] C B Wheeler J. Phys E Scientific Instruments 6 (1973), pp. 205-207

1. A gamma-ray spectrometer comprising a scintillation body for receiving gamma-rays and generating photons therefrom and a photodetector optically coupled to the scintillation body so as to detect photons generated by scintillation events in the scintillation body, wherein the photodetector comprises:
a photocathode arranged to receive photons from the scintillation body and generate photo-electrons therefrom;
an anode arranged to receive photoelectrons generated at the photocathode; and
a reflecting surface arranged to reflect photons which have passed through the photocathode back towards the photocathode, and wherein a surface of the photocathode and a surface of the anode are in a substantially plane-parallel configuration, and wherein the separation between the anode and photocathode is less than a distance selected from the group comprising 1 mm, 2 mm, 3 mm, 4 mm and 5 mm.

2. A gamma-ray spectrometer according to claim 1, further comprising a housing surrounding the photocathode and the anode, wherein the housing includes a transparent window arranged to allow photons from the scintillation body to enter the housing and be received at the photocathode.

3. A gamma-ray spectrometer according to claim 1, wherein the reflecting surface is within the housing.

4. A gamma-ray spectrometer according to claim 1 wherein the reflecting surface is outside the housing, and wherein the housing includes a transparent window arranged to allow photons which have passed through the photocathode to reach the reflecting surface and be reflected back into the housing.

5. A gamma-ray spectrometer according to claim 1, wherein the anode is configured to allow photons to pass through it.

6. A gamma-ray spectrometer according to claim 5, wherein the anode comprises a transparent conductor.

7. A gamma-ray spectrometer according to claim 5, wherein the anode includes open regions to allow photons to pass through.

8. A gamma-ray spectrometer according to claim 1, wherein the reflecting surface and the anode are on opposing sides of the photocathode.

9. A gamma-ray spectrometer according to claim 1, further comprising a second photocathode arranged such that the first-mentioned photocathode and the second photocathode are located on opposing sides of the anode.

10. A gamma-ray spectrometer according to claim 1, wherein the reflecting surface and the anode are on opposing sides of the second photocathode.

11. A gamma-ray spectrometer according to claim 1, wherein the reflecting surface is a surface of the anode facing the photocathode.

12. A gamma-ray spectrometer according to claim 1, wherein the reflecting surface is a diffuse reflector.

13. A gamma-ray spectrometer according to claim 1, wherein the reflecting surface is a specular reflector.

14. A method of gamma-ray spectrometry comprising providing a gamma-ray spectrometer comprising a scintillation body for receiving gamma-rays and generating photons therefrom and a photodetector optically coupled to the scintillation body so as to detect photons generated by scintillation events in the scintillation body by
receiving photons at a photocathode of the photodetector and generating photo-electrons therefrom,
receiving photoelectrons generated at the photocathode at an anode of the photodetector, and
reflecting photons which have passed through the photocathode back towards the photocathode, and wherein a surface of the photocathode and a surface of the anode are in a substantially plane-parallel configuration, and wherein the separation between the anode and photocathode is less than a distance selected from the group comprising 1 mm, 2 mm, 3 mm, 4 mm and 5 mm.
